(19) United States
(12) Patent Application Publication
(10) Pub. No.: US 2013/0063260 A1
(43) Pub. Date: Mar. 14, 2013

(54) Personal Thermal Monitor

(71) Applicants: David M. Davis, Tucson, AZ (US); Debra A. Davis, Tucson, AZ (US); Kyle S. Davis, Tucson, AZ (US)

(72) Inventors: David M. Davis, Tucson, AZ (US); Debra A. Davis, Tucson, AZ (US); Kyle S. Davis, Tucson, AZ (US)

(21) Appl. No.: 13/608,984

(22) Filed: Sep. 10, 2012

Related U.S. Application Data
(60) Provisional application No. 61/573,589, filed on Sep. 9, 2011.

(51) Int. Cl. G08B 21/02; G08B 1/08

(52) U.S. Cl. 340/539.25; 340/573.1; 340/584; 340/539.1

(57) ABSTRACT

A personal thermal monitor, comprising a thermally activated circuit configured to provide a first signal when an ambient temperature is greater than a first temperature, a switch in communication with said thermally activated circuit, a controller in communication with said switch and comprising an audible alarm.

### CROSS-REFERENCE TO RELATED APPLICATIONS

This Applications claims priority from a U.S. Provisional Application having Ser. No. 61/573,589 and filed Sep. 9, 2011. The United States Provisional Application having Ser. No. 61/573,589, is incorporated by reference herein.

### FIELD OF THE INVENTION

The present invention relates generally to a personal thermal monitor and more specifically it relates to a thermally activated warning circuit for activating a warning alarm.

### BACKGROUND OF THE INVENTION

Personal monitors have been in use for years. The main drawback with prior art personal monitors are these products are passive for general ‘PANIC’ protection, and need human decisions and interaction for the activation of alarm or ‘PANIC’ features in needed situations through a human interface.

Another problem with conventional personal monitors are that there is no built in automatic safety mechanism to alert any intended carrier/user, or anyone immediately proximate to the carrier/user of any of these devices or transmitters of any potential safety issues concerning unhealthy temperature extremes.

Another problem with conventional personal monitors are that there is no built in automatic safety mechanism to alert a parent, child, owner, or monitoring authority of these devices or transmitters not immediately proximate to the device to any potential safety issues concerning potentially unhealthy temperature extremes.

### SUMMARY OF THE INVENTION

A personal thermal monitor is presented. Applicants' apparatus comprises a thermally activated warning circuit for activating a warning alarm proximately located, wirelessly remote, or via GPS, or GSM/CDMA cellular phone type of tracking circuit autonomously when the ambient temperature of the device exceeds preset high and or low safety health limits to inform and or warn a supervising person or authority of a potential health issue. Applicants' apparatus can assist the parents of a child, the caretakers of debilitated or elderly or frail persons, the managers of fire-fighters, the owners of dogs or cats (pets) etc., and others, to know when a health safety risk with a potentially unhealthy out of temperature range event exists, and automatically triggers or activates an alarm

### BRIEF DESCRIPTION OF THE DRAWINGS

The invention will be better understood from a reading of the following detailed description taken in conjunction with the drawings in which like reference designators are used to designate like elements, and in which:

FIG. 1 is a schematic of a high or low temperature actuating trigger circuit.

FIG. 2 is a schematic of a high and/or low temperature actuating trigger circuit.

FIG. 3 is a block diagram of components comprising temperature actuating circuit with monitor/alarm technology.

FIG. 4 is a block diagram of components comprising temperature actuating circuit with transmitter/transceiver technology.

FIG. 5 is a block diagram of components comprising temperature actuating circuit in transmitter/transceiver with base paging technology.

FIG. 6 is a block diagram of components comprising temperature actuating circuit with GPS/GSM/CDMA tracking technology.

FIG. 7 is a block diagram of components comprising temperature actuating circuit in GPS/GSM/CDMA global interface.

### DETAILED DESCRIPTION OF PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Applicants' thermally activated warning circuit substantially departs from the conventional concepts and designs of the prior art, and in so doing provides an apparatus primarily developed for the purpose of activating a warning alarm proximately located, wirelessly remote, or via GPS GSM/CDMA type of tracking circuit autonomously when the ambient temperature of the device exceeds preset high and or low pre set limits to inform and or warn a supervising person or authority of a potential health issue. Those skilled in the art will appreciate that GSM (Global System for Mobile Communications, originally Groupe Special Mobile), is a standard set developed by the European Telecommunications Standards Institute (ETSI) to describe protocols for second generation (2G) digital cellular networks used by mobile phones.

Those skilled in the art will appreciate that code division multiple access (CDMA) is a channel access method used by various radio communication technologies. This technology allows several transmitters to send information simultaneously over a single communication channel. This allows several users to share a band of frequencies (see bandwidth). This concept is called multiple access. CDMA employs spread-spectrum technology and a special coding scheme (where each transmitter is assigned a code) to allow multiple users to be multiplexed over the same physical channel.

The attached Figures. illustrate Applicants' thermally activated warning circuit. In certain embodiments, that thermally activated warning circuit comprises a single limit thermally activated integrated circuit (IC), wherein that thermally activated IC is programmed to provide a signal when the ambient temperature is greater than a programmed threshold temperature. In certain embodiments, that thermally activated warning circuit comprises a Texas Instrument #TMP300, 302A-D, or 303, device 10.

In certain embodiments, that thermally activated warning circuit comprises a multi limit thermally activated integrated circuit, wherein the thermally activated warning circuit provides a first signal when the ambient temperature is greater than a first threshold temperature, and wherein the thermally activated warning circuit provides a second signal when the ambient temperature is less than a second threshold temperature. In certain embodiments, that thermally activated warning circuit comprises an Analog Devices #ADT6501-4 to sense temperature and activate at a temperature programmed or selected in product design.

In certain embodiments, a switching amperage is increased. In certain embodiments, that thermally activated warning circuit comprises a switching component such as the Fairchild 2N7000. In certain embodiments, that thermally activated warning circuit comprises a circuit isolated from a transmission circuit by using component such as the Vishay SFH610, or Fairchild HSR312 type of optoisolators. In certain embodiments, that thermally activated warning circuit comprises, a transistor or relay type device to switch larger loads or isolating requirements.

The thermal switch 10 comprises an integrated circuit that activates at a predetermined temperature specified by internal or external programming components, such as varied resistor values 12, for triggering or activation of a secondary circuit at a specific and repeatable temperature. The electronic switch 15 activates the alarm independently or parallel to the human interface switch 255 on the alarm device or transmitter such as a power transistor, relay, or optoisolator.

The transmitter is a circuit such as that within an automotive key fob type alarm transmitter 260. In certain embodiments, the transmitter comprises a SCYTEK #T2, #T5. In certain embodiments, the transmitter comprises a code learning Asian-Wolf Stingpro. In certain embodiments, the transmitter comprises a GPS tracking device 280 such as the Brickhouse Security Spark Nano, or P-Track Pro.

In certain embodiments, the alarm comprises a circuit that when activated would generate audible and or visual alarm feedback. In certain embodiments, the alarm is activated by over or under temperature sensing circuit 100. In certain embodiments, the alarm is activated by over and or under temperature sensing circuit 200. In certain embodiments, the alarm is activated by thermal circuit 300. In certain embodiments, radio frequency transmission of alarm is caused by the activation of wireless transmitter by the temperature circuit 400 with or without monitoring 500, and or by activation of the wireless transmitter for GPS/GSM/CDMA 600 with or without monitoring 700.

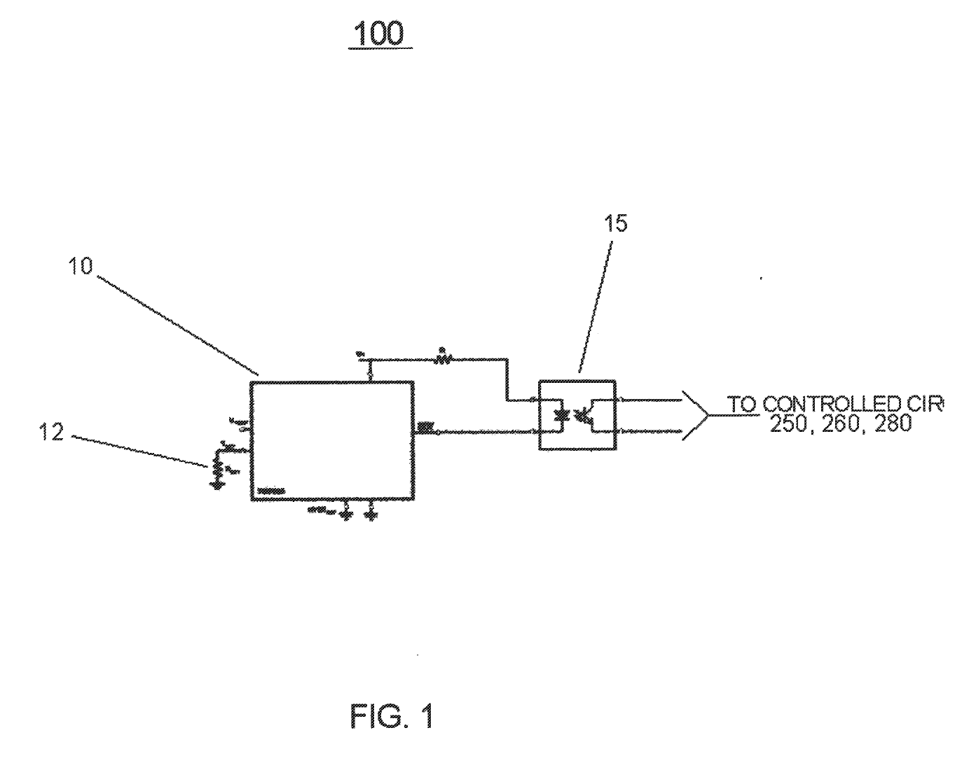

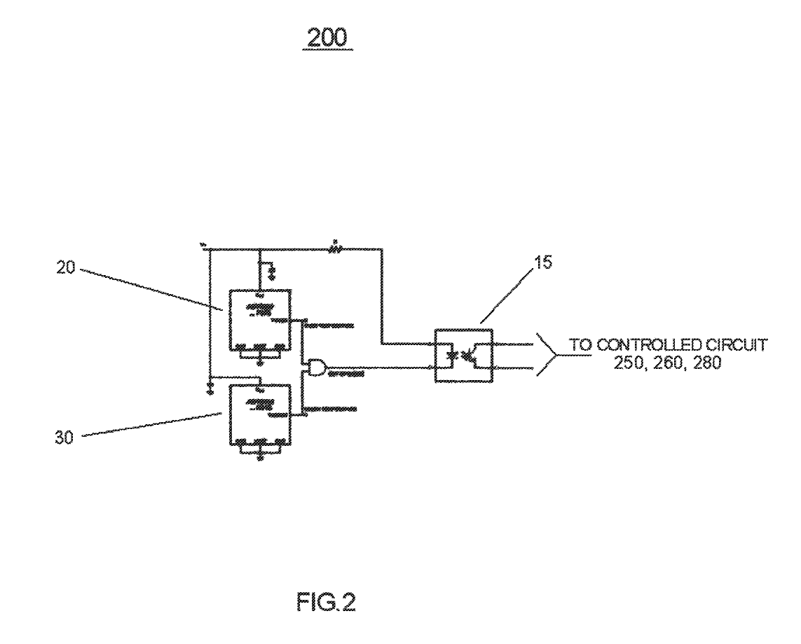

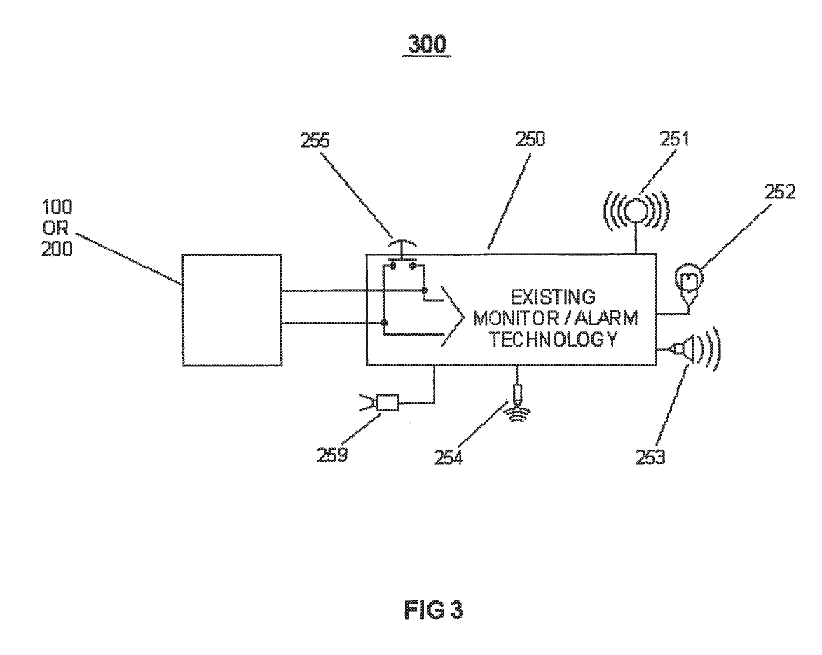

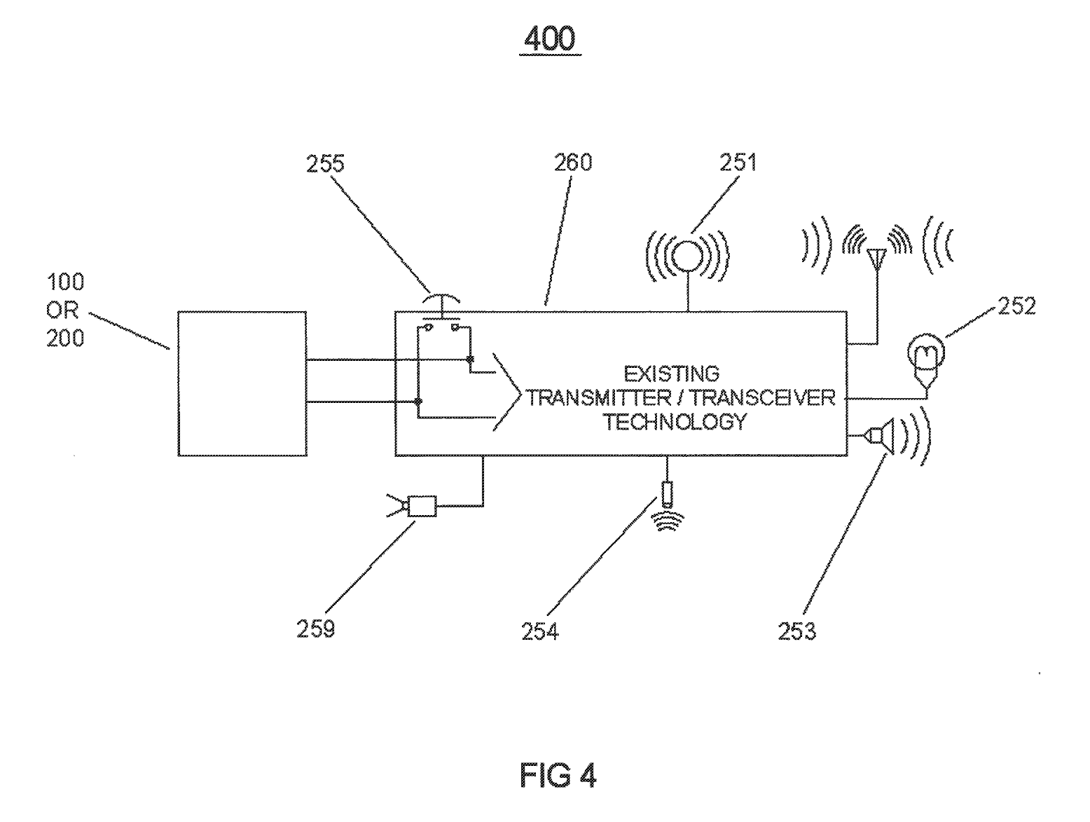

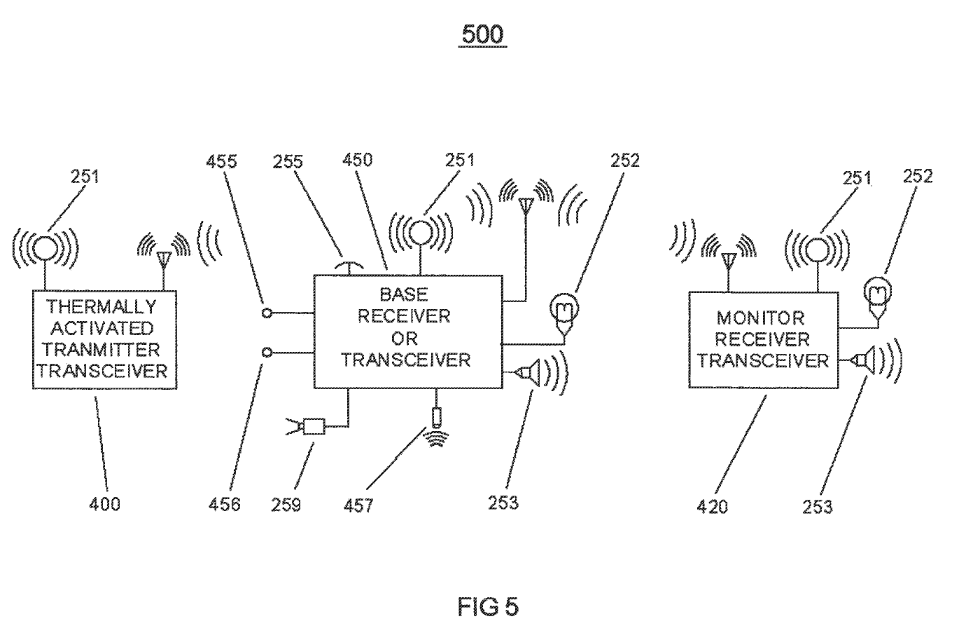

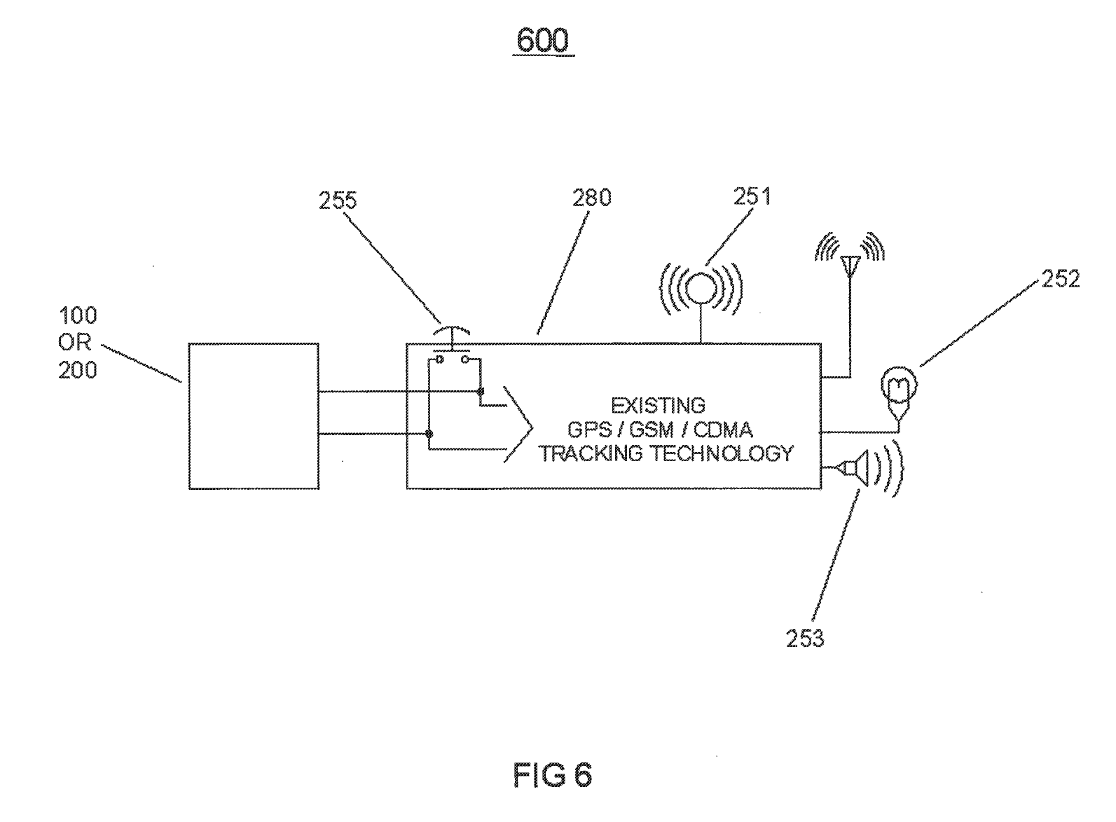

Referring to FIG. 1, thermal switch 10 is an integrated circuit utilizing a device internally that activates at a predetermined temperature specified by internal or external programming components, such as varied resistor values 12, for triggering or activation of a secondary circuit such as proximate alarm 250 (FIG. 3), wireless alarm transmission 260 (FIG. 4), or GPS GSM/CD MA cellular location type alarm 280 (FIG. 6) at a specific and repeatable temperature. The thermal switch is an integrated circuit (IC) such as the single limit Texas Instruments #TMP300, 302A-D, 303, etc. 10 or multi limit Analog Devices #ADT6501-4 20 (FIG. 2) or 30 (FIG. 2) to sense temperature and consistently activate a secondary circuit such as a wired (FIG. 3) at a temperature programmed or selected in the product design. In other embodiments, the thermal switch comprises one or more electromechanical bi-metallic switches. In other embodiments, the thermal switch comprises one or more solid state thermal monitoring devices coupled to thermal set point analog or digital devices set to switch. In other embodiments, the thermal switch comprises complete or interrupt circuits at programmed thermal set points.

The electronic switch 15 activates the alarm independently or parallel to the human interface switch 255 FIG. 3 on the alarm device 250 (FIG. 3), wireless alarm transmission 260 (FIG. 4), or GPS GSM/CDMA location type alarm 280 (FIG. 6), and is a device such as a power transistor, relay, or optoisolator. In certain embodiments, an electronic switch is used. In certain embodiments, the electronic switch comprises an electromagnetic relay, a transistor such as the Fairchild 2N7000, or optoisolator such as the Vishay SFH610, optoisolator, or relay type device capable to handle higher amperage or isolated switching loads from smaller actuation current.

In certain embodiments, the transmitter comprises a circuit such as that within an automotive key fob type alarm transmitter 260 (FIG. 4) such as the SCYTEK #T2, #T5, or GPS tracking device 280 such as the Brickhouse Security Spark Nano, or P-Track Pro. In certain embodiments, the transmitter comprises a wireless baby monitor transmitter or an automotive security system key fob type transmitter 400 (FIG. 4) with or without optional call button 255 (FIG. 4). In certain embodiments, the transmitter comprises a pet collar tracker or child location style of GPS, GSM or CDMA type locating transmitter 600 (FIG. 6) with single set point thermal actuation circuit 100 (FIG. 1), or multiple set point thermal actuation circuit 200 (FIG. 2).

In certain embodiments, the transmitter comprises an independent key fob type of attachable device to attach or put into a pocket, or it could be built into another product such as a child's car seat, a pet collar, or a fireman's accessory as witnessed by anyone skilled in the art could reduce to practice.

The alarm comprises a circuit that when activated would generate audible and or visual alarm feedback to persons either proximate to the temperature sensing circuit 300 (FIG. 3) and activated directly by the thermal circuit, and or by radio frequency transmission of alarm by the activation of wireless transmitter 400 (FIG. 4) by the single set point temperature circuit 100 (FIG. 4), or by the multi point temperature circuit 200 (FIG. 4). A wired usage could utilize a hard wired audio enunciator 253 (FIG. 3) and or visual illuminator 252 (FIG. 3) for attracting attention immediately proximate to the out of temperature range event as well as access ultrasonic and or audio 254 (FIG. 3) and video 259 (FIG. 3) signals for remote wired monitoring or alarm triggering if so equipped. A wireless usage could utilize a baby monitor or automotive type alarm receiver or transceiver FIG. 5 450 or full system such as the SCYTEK Astra #777 automotive alarm 500 FIG. 5 with audio enunciation 253 FIG. 5 and or visual illumination 252 FIG. 5 to attract attention proximate to the source of the out of range thermal actuation.

A wireless usage such as depicted in FIG. 5 could use a remote receiver such as a baby monitor parental base or full function transceiver 450 (FIG. 5) for wireless remote monitoring with audio enunciation 253 (FIG. 5), and/or visual illumination 252 (FIG. 5) to attract attention, or an automotive 2-way remote transceiver 420 (FIG. 5) such as the SCYTEK two-way #2WVG8, #2W-TCN with any combination of, but not limited to vibration 251 (FIG. 5), audio enunciation 253 (FIG. 5) and visual illumination 252 (FIG. 5) to attract attention.

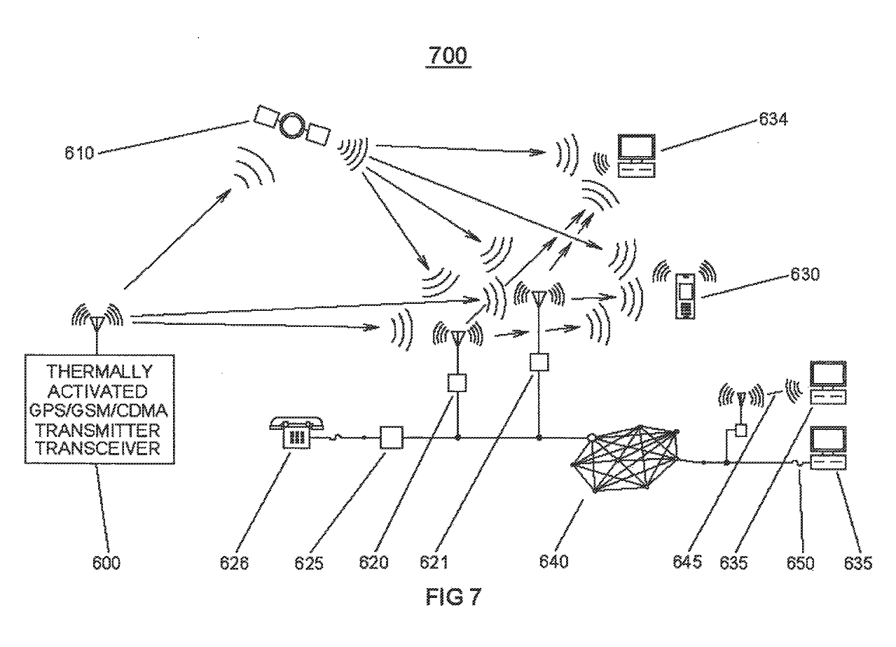

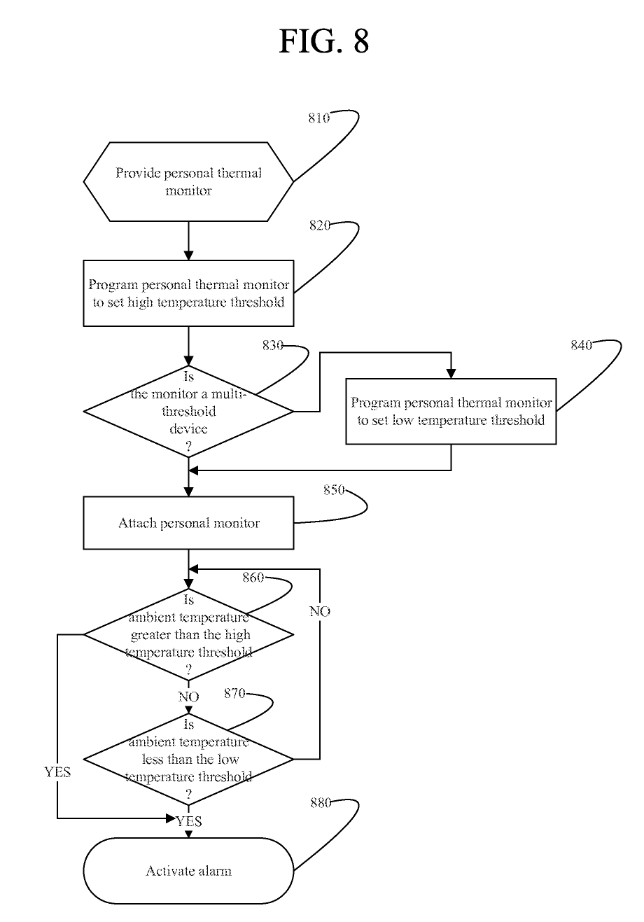

In certain embodiments, a wireless implementation as depicted in 500 (FIG. 5) can access ultrasonic and or audio 254 FIG. 4 and video 259 FIG. 4 signals for remote wireless monitoring or alarm triggering to transmit to the monitoring receiver or transceiver 420 FIG. 5. GPS locator type usage such as depicted in FIG. 7 would utilize a GPS locator 600 such as the 17 Brickhouse Security Spark Nano or P-Track Pro GPS with associated monitoring software for wireless and or internet access for alarm. The proximate alarm would be any discrete or included device such as but not limited to: vibration 251 (FIG. 6) visual illumination 252 (FIG. 6), audio enunciation 253 FIG. 6, and the like, that attracts attention proximate to the location of the out of temperature range incident through the human senses such as touch, sight or sound.

In certain embodiments, for remote monitoring, an alarm comprises a discrete or included device such as but not limited to: vibration 251 (FIG. 6), visual illumination 252 (FIG. 6), audio enunciation 253 (FIG. 6), with the addition of smart communications such as SMS text with preprogrammed messages or real time GPS coordinates, graphical placement and ‘PANIC’ or such indicator on a map, or call from a transmitter, transceiver or two-way remote 600 (FIG. 7) with a preprogrammed Short Message Service (SMS) messages through the GSM/CDMA 621 (FIG. 7) communication system, or municipality/government communication systems 620 (FIG. 7) to a land-line phone 626 (FIG. 7), cell phone , pager, or PDA type of device 630 (FIG. 7), or visual graphics with or without audio warnings to a cell phone, or PDA type device 630 (FIG. 7) running appropriate monitoring applications, computers 635 (FIG. 7) with satellite 610 (FIG. 7), municipality/government communication frequencies 620 (FIG. 7) connectivity running the appropriate monitoring applications, or internet connected 640 (FIG. 7) computers running the appropriate monitoring applications.

In certain embodiments, the thermal protection circuit 100 (FIG. 1) or 200 (FIG. 2) comprising the programmable thermal switch and an electronic switch such as an optoisolator would be integrated into a circuit for activation independently or in parallel to a physical ‘PANIC’ type button or switch 255 (FIG. 4) on a wireless transmitter 260 (FIG. 4), or 280 (FIG. 6). This transmitter such as a ‘baby monitor’, pet tracker or vehicle alarm transmitter 400 (FIG. 4), or GPS type tracking transmitter 600 (FIG. 6) would be operable by not only human intervention via tactile feedback button operation 255 (FIGS. 4, and 6), but autonomously or automatically in the event of a potentially life-threatening out of temperature range event.

In the event of transmitter activation, the proximate alarm of the product specification would then be activated such as that any combination of, but not limited to vibration 251 (FIGS. 4, 5, and 6), visual illumination 252 (FIGS. 4, 5, and 6), and audio enunciation 253 (FIGS. 4, 5, and 6) of physical sensory stimulation for car seat, ‘bouncy seat’, crib or vehicle type alarms.

In wireless vehicle alarm remote types of installations 500 (FIG. 5), alarm options could be programmed and activated for safety and or surveillance choices such as utilizing alarm feature connections for automatically lowing windows 455 (FIG. 5), unlocking doors 456 (FIG. 5), or activating ultrasonic and or audio 457 (FIG. 5) and or video surveillance 259 (FIG. 5) for remote monitoring or sending monitoring information to the owner or monitoring base 450 (FIG. 5) or any receiver or 2-way transceiver 420 (FIG. 5) any combination of, but not limited to vibration 251 (FIGS. 4, 5, and 6), visual illumination 252 (FIGS. 4, 5, and 6), and audio enunciation 457, and audio alarm 253 (FIGS. 4, 5, and 6) sensory feedback in the event of an activating occurrence.

For GPS 700 (FIG. 7) utilization with or without GSM/CDMA type tracking, the alarm action would be more remote communications based such as with the addition of smart communications such as SMS text with preprogrammed messages or real time GPS coordinates, graphical placement and ‘PANIC’ or ‘TEMP’ type of indicator on a map, or call from a transmitter, transceiver or two-way remote 600 (FIG. 7) with a preprogrammed Short Message Service (SMS) messages through the GSM/CDMA 621 (FIG. 7) communication system, or municipality/government communication systems 620 (FIG. 7) to a land-line phone 626 (FIG. 7), cell phone, pager, or PDA type of device 630 (FIG. 7),or visual graphics with or without audio warnings to a cell phone, or PDA type device 630 (FIG. 7) running appropriate monitoring applications, mobile or stationary computers 634 (FIG. 7) with satellite 610 (FIG. 7), municipality/government communication frequencies 620 (FIG. 7) connectivity running the appropriate monitoring applications, or interne connected 640 (FIG. 7) computers, tablets, or PDA type of device 635 (FIG. 7) wirelessly connected 645 (FIG. 7) or cable connected 650 (FIG. 7) running the appropriate monitoring applications.

Another embodiment of the invention with the vehicle alarm wireless type of integration would be to use the thermal circuit and electronic switch in a vehicle passenger cabin mount 450. (FIG. 4) As most vehicle type alarm systems utilize an audio and or ultrasonic or physical presence sensor 457 (FIG. 5) for sensing internal cabin presence, that input could be utilized in a CMOS “AND” type of electronic gate in the trigger such as that when any internal occupation is sensed in conjunction with a potentially life-threatening out of temperature range event, the alarm would be activated.

In this case, the alarm would activate and if equipped with power locks 456 (FIG. 5) or windows 455 (FIG. 5), they could be programmed to activate as desired for safety and accessibility. Additionally, if this system is equipped with a receiver or two-way transceiver 420 (FIG. 5), a signal would be sent to it stating an alarm situation of a potentially life-threatening out of temperature range event occurrence. A receiver or two way transceiver 420 (FIG. 5) with audio and or video reception capabilities could also be signaled with transmission of audio 457 (FIG. 5) and or video 459 (FIG. 5) from the vehicle or monitoring site if so equipped. Another version of the vehicle alarm type of wireless transmitter would be to use the new transmitter circuit 400 (FIG. 4 in a transceiver mounting configuration such as 450 (FIG. 5) in a car seat, bouncy seat, or crib mount.

As most vehicle type alarm systems utilize an audio and or ultrasonic or physical presence sensor 457 (FIG. 4) for sensing cabin presence, that input could be utilized in a CMOS style “AND” type of electronic circuit trigger such as that when any seat or crib occupation is sensed in conjunction with a potentially life-threatening out of temperature range event, the alarm would be activated proximately, as well as transmitted to a receiver or transceiver 420 (FIG. 5). Additionally, if this system is equipped with a receiver or transceiver 420 (FIG. 5), a signal would be sent to it stating an alarm situation

Applicants' method utilizes Applicants' personal thermal monitor. Referring now to

FIG. 8, in step 810 the method provides a personal thermal monitor. In certain embodiments, in step 810 the method provides Applicant's thermal monitor which comprises controller 250 in combination with the thermal-activated switch 100. In certain embodiments, in step 810 the method provides Applicant's thermal monitor which comprises controller 250 in combination with the thermal-activated switch 200

In certain embodiments, in step 810 the method provides Applicant's thermal monitor which comprises controller 260 in combination with the thermal-activated switch 100. In certain embodiments, in step 810 the method provides Applicant's thermal monitor comprises controller 260 in combination with the thermal-activated switch 200.

In certain embodiments, in step 810 the method provides Applicant's thermal monitor which comprises a thermally activated transceiver 400 which can provide a wireless alarm message to a remote monitor receiver 420. In certain embodiments, in step 810 the method provides a tracking device in combination with Applicants' thermally-activated switch 100. In certain embodiments, in step 810 the method provides a tracking device in combination with Applicants' thermally-activated switch 200.

In certain the tracking device of step 810 comprises a GPS module to determine the geographical location of Applicants' personal thermal monitor. In certain embodiments, the tracking device of step 810 communicates using GSM technology. In certain embodiments, the tracking device of step 810 communicates using CDMA technology.

In step 820, the method programs the personal thermal monitor of step 810 to set a high temperature threshold. In certain embodiments, step 820 is performed by a manufacturer of the personal thermal monitor of step 810. In certain embodiments, step 820 is performed by a seller in commerce of the personal thermal monitor of step 810. In certain embodiments, step 820 is performed by a user of the personal thermal monitor of step 810.

In step 830, the method determines if the personal monitor of step 810 comprises a multi-threshold device. In certain embodiments, step 830 is performed by a manufacturer of the personal thermal monitor of step 810. In certain embodiments, step 830 is performed by a seller in commerce of the personal thermal monitor of step 810. In certain embodiments, step 830 is performed by a user of the personal thermal monitor of step 810.

If the method determines in step 830 that the personal monitor of step 810 comprises a multi-threshold device, then the method transitions to step 840 wherein the method programs the personal thermal monitor of step 810 to set a low temperature threshold. In certain embodiments, step 830 is performed by a manufacturer of the personal thermal monitor of step 810. In certain embodiments, step 830 is performed by a seller in commerce of the personal thermal monitor of step 810. In certain embodiments, step 830 is performed by a user of the personal thermal monitor of step 810.

In step 850, the method disposed the fully-programmed personal thermal monitor at a desired location. In certain embodiments, step 850 comprises attaching the fully-programmed personal thermal monitor to a person's body, clothing, or accessory such as and without limitation a wallet, watch, hand bag, purse, attache case, and the like. In certain embodiments, step 850 comprises attaching the fully-programmed personal thermal monitor to a pet companion. In certain embodiments, step 850 comprises attaching the fully-programmed personal thermal monitor to one animal in a grouping of animals, such as one horse in a corral or barn, one chicken in a chicken coop, and the like. In certain embodiments, step 850 comprises attaching the fully-programmed personal thermal monitor to an article of manufacture, such as and without limitation a television, a computing device, an engine, and the like.

In step 860, the method determines if the ambient temperature is greater than the high temperature threshold. If the method determines in step 860 that the ambient temperature is greater than the high temperature threshold, then the method transitions from step 860 to step 880 and activates an alarm.

Alternatively, if the method determines in step 860 that the ambient temperature is not greater than the high temperature threshold, then the method transitions from step 860 to step 870 wherein the method determines if the ambient temperature is less than the low temperature threshold. If the method determines in step 870 that the ambient temperature is not less than the high temperature threshold, then the method transitions from step 870 to step 860, and continues as described herein.

If the method determines in step 870 that the ambient temperature is less than the low temperature threshold, then the method transitions from step 870 to step 880 and activates an alarm. In certain embodiments, step 880 comprises generating an audible alarm. In certain embodiments, step 880 comprises generating a vibrating alarm. In certain embodiments, step 880 comprises causing a visual alarm to illuminate. In certain embodiments, step 880 comprises enunciating an audible message that an alarm condition exists.

In certain embodiments, step 880 comprises providing a signal to a remote monitor device. In certain embodiments, step 880 comprises wirelessly providing a signal to a remote monitor device.

In certain embodiments, step 880 comprises causing the remote monitoring device to generate an audible alarm. In certain embodiments, step 880 comprises causing the remote monitoring device to generate a vibrating alarm. In certain embodiments, step 880 comprises causing the remote monitoring device to illuminate a visible alarm. In certain embodiments, step 880 comprises causing the remote monitoring device to enunciate an audible message that an alarm condition exists.

While the preferred embodiments of the present invention have been illustrated in detail, it should be apparent that modifications and adaptations to those embodiments may occur to one skilled in the art without departing from the scope of the present invention as set forth herein.

We claim:

1. A personal thermal monitor, comprising:
a thermally activated circuit configured to provide a first signal when an ambient temperature is greater than a first temperature;
a switch in communication with said thermally activated circuit;
a controller in communication with said switch and comprising an audible alarm.

2. The personal thermal monitor of claim 1, wherein said thermally activated circuit can be adjusted to vary said first temperature.

3. The personal thermal monitor of claim 1, wherein said controller further comprises a visual alarm.

4. The personal thermal monitor of claim 3, wherein said controller further comprises a vibrating alarm.

5. The personal thermal monitor of claim 4, wherein said controller further comprises a video camera.

6. The personal thermal monitor of claim 5, further comprising a wireless transmitter.

7. A personal thermal monitor, comprising:
a thermally activated circuit configured to provide a first signal when an ambient temperature is greater than a first temperature, and wherein said thermally activated circuit configured to provide a second signal when an ambient temperature is less than a second temperature;
a switch in communication with said thermally activated circuit;
a controller in communication with said switch and comprising an audible alarm wherein said controller comprises an audible alarm.

8. The personal thermal monitor of claim 7, wherein said thermally activated circuit can be adjusted to vary both said first temperature and said second temperature.

9. The personal thermal monitor of claim 8, wherein said controller further comprises a visual alarm.

10. The personal thermal monitor of claim 9, wherein said controller further comprises a vibrating alarm.

11. The personal thermal monitor of claim 10, wherein said controller further comprises a video camera.

12. The personal thermal monitor of claim 11, further comprising a wireless transmitter.

13. A method to provide a temperature alarm, comprising:
providing a thermally activated circuit configured to provide a first signal when an ambient temperature is greater than a first temperature, a switch in communication with said thermally activated circuit, and a controller in communication with said switch and comprising an audible alarm wherein said controller comprises an audible alarm;
setting a value for said first temperature;
determining that an ambient temperature is greater than said first temperature; and
activating said audible alarm.

14. The method of claim 13, wherein:
said controller is disposed in a vehicle comprising powered door locks and powered windows;
said controller is configured to operate said powered door locks and said powered windows
said method further comprising:
opening said powered door locks; and
lowering said powered windows.

15. The method of claim 13, wherein said controller further comprises a visual alarm, further comprising:
determining that an ambient temperature is greater than said first temperature; and
activating said visual alarm.

16. The method of claim 14, wherein said controller further comprises a vibrating alarm, further comprising:
determining that an ambient temperature is greater than said first temperature; and
activating said vibrating alarm.

17. The method of claim 16, wherein said controller further comprises a wireless transmitter, further comprising:
determining that an ambient temperature is greater than said first temperature;
wirelessly sending an alarm signal to a remote monitoring device comprising a wireless receiver and an audible alarm;
generating an audible alarm by said remote monitoring device.

18. A method to provide a temperature alarm, comprising:
providing a thermally activated circuit configured to provide a first signal when an ambient temperature is greater than a first temperature and a second signal when an ambient temperature is less than a second temperature, a switch in communication with said thermally activated circuit, and a controller in communication with said switch and comprising an audible alarm wherein said controller comprises a first audible alarm and a second audible alarm;
setting a value for said first temperature;
setting a value for said second temperature;
operative if an ambient temperature is greater than said first temperature, activating said first audible alarm;
operative if an ambient temperature is less than said temperature, activating said second audible alarm.

19. The method of claim 18, wherein said controller further comprises a first visual alarm and a second visual alarm, further comprising:
operative if an ambient temperature is greater than said first temperature, activating said first visual alarm;
operative if an ambient temperature is less than said temperature, activating said second visual alarm.

20. The method of claim 19, wherein said controller further comprises a wireless transmitter, further comprising:
operative if an ambient temperature is greater than said first temperature, wirelessly sending a first alarm signal to a remote monitoring device comprising a wireless receiver and a first audible alarm and a second audible alarm, and activating said first audible alarm;
operative if an ambient temperature is less than said second temperature, wirelessly sending a second alarm signal to said remote monitoring device, and activating said second audible alarm.

21. The method of claim 20, wherein said controller further comprises a video camera and wherein said remote monitoring device further comprises a video display, further comprising:
operative if an ambient temperature is greater than said first temperature, wirelessly sending a first alarm signal and a video signal to said remote monitoring device, activating said first audible alarm, and displaying a video image on said video display;
operative if an ambient temperature is less than said second temperature, wirelessly sending a second alarm signal and a video signal to said remote monitoring device, activating said second audible alarm, and displaying a video image on said video display.
